(19) United States
(12) Patent Application Publication
(10) Pub. No.: US 2005/0141222 A1
(43) Pub. Date: Jun. 30, 2005

(54) Lighting device and temperature detection method thereof

(75) Inventors: Shun-Chieh Yang, Taipei (TW); Bang-Ji Wang, Taipei (TW); Hung-Jen Wei, Nantou (TW); Tzu-Huan Hsu, Taipei (TW); Shen-Chang Lu, Penghu (TW); Chang-Chien Li, Taipei (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/023,462

(22) Filed: Dec. 29, 2004

(30) Foreign Application Priority Data
Dec. 31, 2003 (TW) 92137618

(51) Int. Cl. F21V 9/00

(52) U.S. Cl. 362/293

(57) ABSTRACT

A lighting device and a temperature detection method thereof. The temperature detection method includes the following steps. A lighting device with an invisible-light filter is provided. The invisible-light filter reflects part of an invisible light of a light beam, generated by the lighting device, back to the lighting device to form a first beam. A thermally-sensitive detection device is then disposed in the lighting device, outside a propagation path of the first beam. The temperature in the lighting device is detected by the thermally-sensitive detection device.

### BACKGROUND

The invention relates to an image projection apparatus, a lighting device, and a temperature detection method thereof, and in particular, to a temperature detection method that can accurately detect the temperature of a light source of the lighting device.

In a conventional image projection apparatus such as a projector, the temperature of a lighting device, such as a discharge lamp, is detected at several predetermined positions therein (ex: on the housing, the light source, the post, and etc.) to make sure that the lighting device can operate within a predetermined range of the temperature.

To detect the temperature, a thermally-sensitive detection device such as a thermal couple or an infra-ray (IR) detector is utilized. When the thermal couple is utilized, it is adhered to the lighting device at several positions and connected to a cable. If the number of the thermal couple exceeds a predetermined number or the cable is placed in an incorrect position, the cooling flow field in the lighting device may be disturbed by the cable so that the temperature cannot be detected accurately.

Additionally, referring to FIG. 1a, an invisible-light filter 12a is disposed in front of a light source 11 in a lighting device 10a of a projector, such as a DLP projector, to separate UV and IR. When a light beam from the light source 11 passes through the invisible-light filter 12a, it transmits and reflects simultaneously. The reflected light beam is focused around a post 13 and the light source 11 so that the detected temperature exceeds the actual temperature.

Furthermore, as shown in FIG. 1b, U.S. pat. appli. Ser. No. 10/604,722 discloses an image projection apparatus 10b with a slanted invisible-light filter 12a. In the image projection apparatus 10b, the invisible-light filter 120b is disposed in a manner such that an actuate angle is formed between a normal thereof and an optical path. Due to such an arrangement, the reflected light beam may be focused on a cathode cable 14 of the lighting device 10 so that the detected temperature exceeds the actual temperature.

### SUMMARY

In view of this, an embodiment of the invention provides a lighting device and temperature detection method thereof that can accurately detect the temperature of a light source.

Another object of an embodiment of the invention is to provide an image projection apparatus that can accurately detect the temperature of a light source.

Accordingly, an embodiment of the invention provides a temperature detection method for a lighting device. The temperature detection method comprises the following steps. The lighting device is provided, comprising an invisible-light filter deposed slantwise in front of the lighting device. The invisible-light filter reflects part of an invisible light of a light beam, generated by the lighting device, back to the lighting device to form a first beam. A thermally-sensitive detection device is provided in the lighting device outside a propagation path of the first beam to avoid the heat thereof. The temperature in the lighting device is detected by the thermally-sensitive detection device.

It is noted that the invisible-light filter is preferably deposed slantwise in front of the lighting device to avoid the first beam overlapping the light source of the lighting device.

It is understood that the thermally-sensitive detection device may be a thermal couple or be made of thermally-sensitive paint.

In an embodiment of the invention, a lighting device is provided, comprising a light source, a reflective housing, a cathode cable, and an invisible-light filter. The light source generates a light beam. The reflective housing comprises an opening and receiving space. The light source is disposed in the receiving space so that the light beam propagates along an optical path from the receiving space via the opening. The cathode cable is electrically connected to the light source, and disposed in the reflective housing. The invisible-light filter is disposed outside the reflective housing to reflect part of an invisible light of the light beam back to the reflective housing to form a first beam. Neither the light source nor the cathode cable is disposed on a propagation path of the first beam. That is, the propagation path of the first beam does not overlap the cathode cable or the light source.

In a preferred embodiment, an angle between a normal of the invisible-light filter and the optical path exceeds zero degrees so that neither the light source nor the cathode cable is disposed in the propagation path of the first beam.

In another preferred embodiment, the reflective housing is elliptical. The light source is disposed on a focus of the elliptical reflective housing. The optical path is a major axis of the elliptical reflective housing. The invisible-light filter is disposed near the opening. The lighting device further comprises a post electrically connected to the light source.

In an embodiment of the invention, an image projection apparatus is provided, comprising a light source, a reflective housing, a cathode cable, an invisible-light filter, and an image module. The light source generates a light beam. The reflective housing comprises an opening and receiving space. The light source is disposed in the receiving space so that the light beam propagates along an optical path from the receiving space via the opening. The cathode cable is coupled to the light source, and disposed in the reflective housing. The invisible-light filter is disposed outside the reflective housing to reflect part of an invisible light of the light beam back to the reflective housing to form a first beam. The image module comprises a plurality of controllable optical reflective surfaces to adjust the light beam and generate a projected beam with optical images. Neither the light source nor the cathode cable is disposed in a propagation path of the first beam. That is, the propagation path of the first beam does not overlap the cathode cable and the light source.

It is noted that the image module may be a digital micro-mirror device or a liquid crystal display panel, and the image projection apparatus may be a projector.

### BRIEF DESCRIPTION OF THE DRAWINGS

An embodiment of the present invention can be more fully understood by reading the subsequent detailed description and examples with references made to the accompanying drawings, wherein:

FIG. 1a is a schematic view of a conventional lighting device;

FIG. 1b is a schematic view of an image projection apparatus as disclosed in U.S. pat. appli. Ser. No. 10/604,722;

FIG. 2 is a schematic view of an image projection apparatus as disclosed in an embodiment the invention;

FIG. 3 is a front view of a lighting device in FIG. 2; and

FIG. 4 is a flowchart of a temperature detection method as disclosed in an embodiment of the invention.

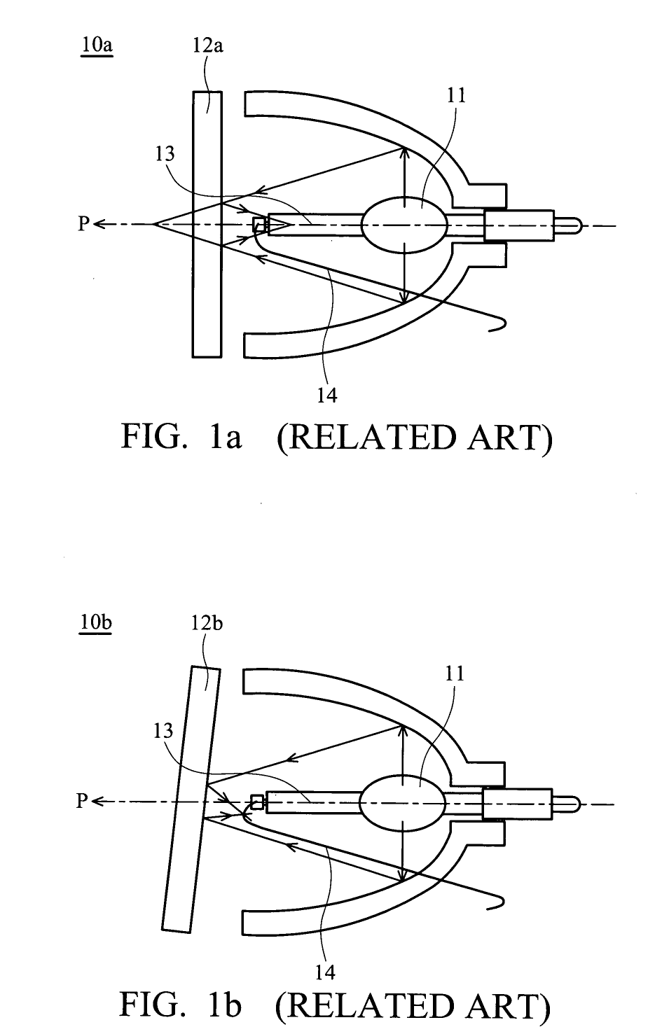

### DETAILED DESCRIPTION

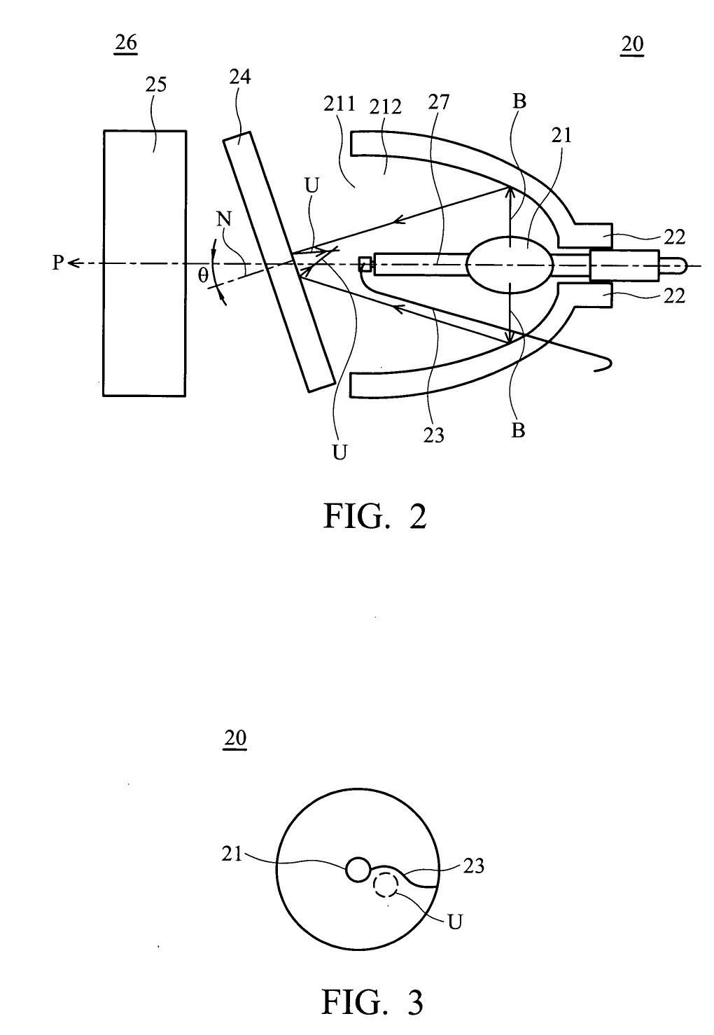

FIG. 2 shows an image projection apparatus 26 of an embodiment of the invention. The image projection apparatus 26 comprises a light source 21, a reflective housing 22, a cathode cable 23, an invisible-light filter 24, an image module 25, and a post 27. The post 27 is electrically connected to the light source 21. The light source 21, the reflective housing 22, the cathode cable 23, the invisible-light filter 24, and the post 27 constitute a lighting device 20 of the invention.

The light source 21 generates a light beam B, and is disposed in receiving space 212 of the reflective housing 22. The reflective housing 22 comprises an opening 211 and the receiving space 212 therein. The reflective housing 22 reflects the light beam B to substantially propagate along an optical path P from the receiving space 212 via the opening 211. In FIG. 2, the reflective housing 22 is elliptical. The light source 21 is disposed on one of focuses of the elliptical reflective housing 22. The optical path P is a major axis of the elliptical reflective housing 22. Furthermore, it is noted that the type of the reflective housing is not limited, and the invisible-light filter 24 can be disposed on a type of housing other than the reflective housing.

The cathode cable 23 is a cable for a cathode (not shown) of the image projection apparatus 26. The cathode cable 23 is electrically connected to the light source 21 and disposed in the reflective housing 22. The image module 25 comprises a plurality of controllable optical reflective surfaces (not shown) to adjust the light beam B and generate a projected beam projecting optical images. It is understood that the image module 25 may be a digital micro-mirror device or a liquid crystal display panel

The invisible-light filter 24 is disposed outside the reflective housing 22 near the opening 211 to reflect part of an invisible light of the light beam B back to the reflective housing 22 to form a first beam U. Due to the arrangement of the invisible-light filter 24, neither the light source 21 nor the cathode cable 23 is disposed in a propagation path of the first beam U. That is, the cathode cable 23 and the light source 21 are disposed in the reflective housing 22 in a manner such that they and the propagation path of the first beam U do not overlap.

In FIG. 2, an angle θ exceeding zero degree is formed between a normal N of the invisible-light filter 24 and the optical path P so that neither the light source 21 nor the cathode cable 23 is disposed in the propagation path of the first beam U.

It is understood that the image projection apparatus 26 may be a projector.

Referring to FIG. 3, since the cathode cable 23 and the light source 21 are disposed in the reflective housing 22 in a manner such that they do not overlap the propagation path of the first beam U, thus, the cathode cable 23 and the light source 21 will not be heated up or even burned down by the first beam U, and the temperature of the light source 21 can be accurately detected.

Similarly, the thermally-sensitive detection device (not shown) is deposed in the lighting device 20 outside a propagation path of the first beam U to avoid the heat thereof during temperature detection.

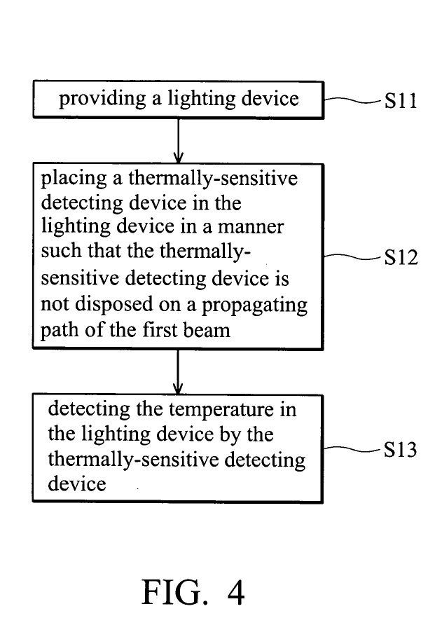

FIG. 4 shows a temperature detection method for a lighting device as disclosed in an embodiment of the invention. The temperature detection method comprises the following steps. In step S11, the lighting device 20 as shown in FIG. 2 is provided, comprising the invisible-light filter 24 for reflecting part of the invisible light of the light beam B back to the reflective housing 22 of the lighting device 20 to form the first beam U. In step S12, a thermally-sensitive detection device is disposed in the lighting device 20 in a manner such that it is out of the propagation path of the first beam U. In step S13, the temperature in the lighting device 20 is detected by the thermally-sensitive detection device.

It is understood that the thermally-sensitive detection device may be a thermal couple or be made of thermally-sensitive paint.

It is noted that to avoid affecting the cooling flow field during temperature detection, few thermally-sensitive detection devices in the lighting device 20 are preferred.

It is also noted that the invisible-light filter 24 is preferably deposed slantwise in front of the lighting device to avoid the first beam U overlapping the light source 21, or the cathode cable 23.

As stated above, since the number of the thermally-sensitive detection device adhered to the lighting device is as few as possible, the temperature of the light source can be accurately detected.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A temperature detection method comprising:
providing a lighting device with an invisible-light filter for reflecting part of an invisible light of a light beam, generated by the lighting device, back to the lighting device as a first beam;
placing a thermally-sensitive detection device in the lighting device outside a propagation path of the first beam; and
detecting the temperature in the lighting device via the thermally-sensitive detection devices.

2. The temperature detection method as claimed in claim 1, wherein the thermally-sensitive detection device is a thermal couple.

3. The temperature detection method as claimed in claim 1, wherein the thermally-sensitive detection device is composed of a thermally-sensitive paint.

4. The temperature detection method as claimed in claim 1, wherein the invisible-light filter is deposed slantwise in front of the lighting device.

5. A lighting device comprising:
a light source for generating a light beam;
a reflective housing including an opening and receiving space, wherein the light source is disposed in the receiving space so that the light beam substantially propagates along an optical path from the receiving space via the opening;
a cathode cable disposed in the reflective housing and electrically connected to the light source; and
an invisible-light filter disposed outside the reflective housing to reflect part of an invisible light of the light beam back to the reflective housing as a first beam;
wherein the light source and the cathode cable are disposed out of a propagation path of the first beam.

6. The lighting device as claimed in claim 5, wherein an angle between a normal of the invisible-light filter and the optical path exceeds zero degrees so that the light source and the cathode cable are disposed out of the propagation path of the first beam.

7. The lighting device as claimed in claim 5, wherein the reflective housing is elliptical, the light source is disposed on a focus of the elliptical reflective housing, and the optical path is a major axis of the elliptical reflective housing.

8. The lighting device as claimed in claim 5, wherein the invisible-light filter is disposed near the opening.

9. The lighting device as claimed in claim 5, further comprising a post electrically connected to the light source.

10. An image projection apparatus comprising:
a light source for generating a light beam;
a reflective housing including an opening and receiving space, wherein the light source is disposed in the receiving space so that the light beam substantially propagates along an optical path from the receiving space via the opening;
a cathode cable disposed in the reflective housing and electrically connected to the light source;
an invisible-light filter disposed outside the reflective housing to reflect part of an invisible light of the light beam back to the reflective housing as a first beam; and
an image module including a plurality of controllable optical reflective surfaces to modulate the light beam and generate a projected beam with an optical image;
wherein the light source and the cathode cable are disposed out of a propagation path of the first beam.

11. The image projection apparatus as claimed in claim 10, wherein an angle between a normal of the invisible-light filter and the optical path exceeds zero degrees so that the light source and the cathode cable are disposed out of the propagation path of the first beam.

12. The image projection apparatus as claimed in claim 10, wherein the reflective housing is elliptical, the light source is disposed on a focus of the elliptical reflective housing, and the optical path is a major axis of the elliptical reflective housing.

13. The image projection apparatus as claimed in claim 10, further comprising a post electrically connected to the light source.

14. The lighting device as claimed in claim 10, wherein the invisible-light filter is disposed near the opening.

15. The image projection apparatus as claimed in claim 10, wherein the image module is a digital micro-mirror device or a liquid crystal display panel.

16. The image projection apparatus as claimed in claim 10, wherein the image projection apparatus is a projector.
